(19) United States
(12) Patent Application Publication
(10) Pub. No.: US 2012/0124873 A1
(43) Pub. Date: May 24, 2012

(54) EMERGENCY-LIGHT INDICATOR

(75) Inventor: SUNG-KEUN LEE, Huizhou (CN)

(73) Assignee: Je Woo Corporation, LTD., Huizhou City (CN)

(21) Appl. No.: 13/165,630

(22) Filed: Jun. 21, 2011

(30) Foreign Application Priority Data
Nov. 19, 2010 (CN) 201020616119.9

(51) Int. Cl. G09F 13/18; G09F 13/00

(52) U.S. Cl. 40/546; 40/541

(57) ABSTRACT

An emergency-light indicator includes a body, a top plate configured on a top of the body, a rotating body including a driving power module and configured on a bottom of the body, and an indication board module. An LED board is configured in the rotating body. The body and the rotating body are installed together via two side covers which are respectively configured at two ends of the body and the rotating body. A mounting slot is structured on a bottom of the rotating body. A rotating side cover is configured at each end of the rotating body. A spring strip is installed to each of the rotating side covers. A groove is structured at each side of the indication board module and the grooves and spring strips are corresponding, thereby the indication board module can be installed to the mounting slot through the spring trips and corresponding grooves.

### FIELD OF THE INVENTION

The present invention relates to an emergency-light indicator, and more particularly to an emergency-light indicator having a detachable indication board module.

### BACKGROUND OF THE INVENTION

Generally, safe passage is a must-have structure in civil and public buildings. Through a safe passage, people in buildings can be quickly evacuated when an emergency situation (e.g., fire situation) is happened. In order to quickly direct people to the safe passage, indication signs are set at conspicuous positions in building. An emergency-light indicator is an apparatus having the indicator sign with self emergency light. Via the emergency light, people can clearly see the indication sign under an emergency situation. In a conventional emergency-light indicator structure, an indication board (having the indication sign on it) and a mounting bracket of the emergency-light indicator have a one-piece structure, which means the indication board is fixedly installed to the emergency-light indicator. Because the indication board is not detachable from the emergency-light indicator, accordingly the conventional emergency-light indicator may need more packaging consumables and more transportation cost. In addition, it is also difficult for a user to replace or clean the indication board in the conventional emergency-light indicator structure.

### SUMMARY OF THE INVENTION

Therefore, one object of the present invention is to provide an emergency-light indicator with a detachable indication board module.

The emergency-light indicator in accordance with an embodiment of the present invention comprises a top plate, a body, a rotating body and an indication board module. The top plate is configured on the top of the body. A driving power module is configured inside the body. The rotating body is configured on the bottom of the body. An LED board is configured inside the rotating body. The body and the rotating body are installed together through two side covers which are respectively configured at two ends of the body and the rotating body. A mounting slot is longitudinal structured on the bottom of the rotating body. A rotating side cover is configured at each end of the rotating body. A spring strip is fixedly installed to each of the rotating side covers. A groove is structured at each right and left side of the indication board module and the two grooves are corresponding to the two spring strips, thereby the indication board module can be installed to or uninstalled from the rotating body through the two spring trips and the corresponding two grooves.

In one embodiment, the above mentioned driving power module comprises an isolation box with a transformer, a chargeable nickel-cadmium cell and a control circuit board inside, and a testing switch and an LED indication light are electrically coupled to the control circuit board.

In one embodiment, the above mentioned rotating body has a round and tubular shape. A contacting surface, of the body and corresponding to the rotating body, has an inner-arc structure. Each of the rotating side covers is capable of rotating its corresponding side cover and a friction is resulted on the contacting surface, thereby corresponding to the body the rotating body can rotate to a specific angle.

In one embodiment, the above mentioned indication board module comprises a first acrylic board, a second acrylic board and a light reflecting board which is configured between the first and the second acrylic boards. A light-block board with a crack structure is configured between the indication board module and the LED board. Light from the LED board is emitted to the first acrylic board through the crack structure of the light-block board while the light-block board is moved to a first position; light from the LED board is emitted to the second acrylic board through the crack structure of the light-block board while the light-block board is moved to a second position; and light from the LED board is emitted to both the first and second acrylic boards through the crack structure of the light-block board while the light-block board is moved to a third position.

In the emergency-light indicator of the present invention, because the spring strips configured in the rotating body are corresponding to the grooves structured on the indication board module, thereby it is easy to install the indication board module to the emergency-light indicator through latching the grooves to the corresponding spring strips; based on the same manner, it is also easy to detach the indication board module from the emergency-light indicator through pulling the indication board module from the rotating body. Because the indication board module is detachable, the indication board module can be packaged independently in the manufacturing process, thereby a reduction of the packaging consumables and transportation cost is achieved. Moreover, it is much convenient for a user to replace or clean the indication board module without detaching the whole emergency-light indicator from a wall. In addition, because along with the rotating body the indication board module is capable of rotating to the body, the emergency-light indicator can be installed on a wall or a ceiling based on an actual situation.

### BRIEF DESCRIPTION OF THE DRAWINGS

The above objects and advantages of the present invention will become more readily apparent to those ordinarily skilled in the art after reviewing the following detailed description and accompanying drawing, in which:

FIG. 1A is a schematic diagram of an overall structure of an emergency-light indicator in accordance with an embodiment of the present invention;

FIG. 1B is a schematic side diagram of the emergency-light indicator in accordance with an embodiment of the present invention;

FIG. 1C is a schematic front diagram of the emergency-light indicator in accordance with an embodiment of the present invention;

FIG. 2 is a schematic exploded diagram of the emergency-light indicator as depicted in FIG. 1;

FIG. 3 is a schematic diagram illustrating the indication board module can be installed to or uninstalled from the rotating body through the two spring strips and the corresponding two grooves;

FIG. 4 is a schematic side cross section diagram of the body and the rotating body; and

FIG. 5 is a schematic diagram illustrating the function of the light-blocking board used on the indication board module.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

To get a clear understanding of the present invention, the following description of the present invention will be given combined with diagrams.

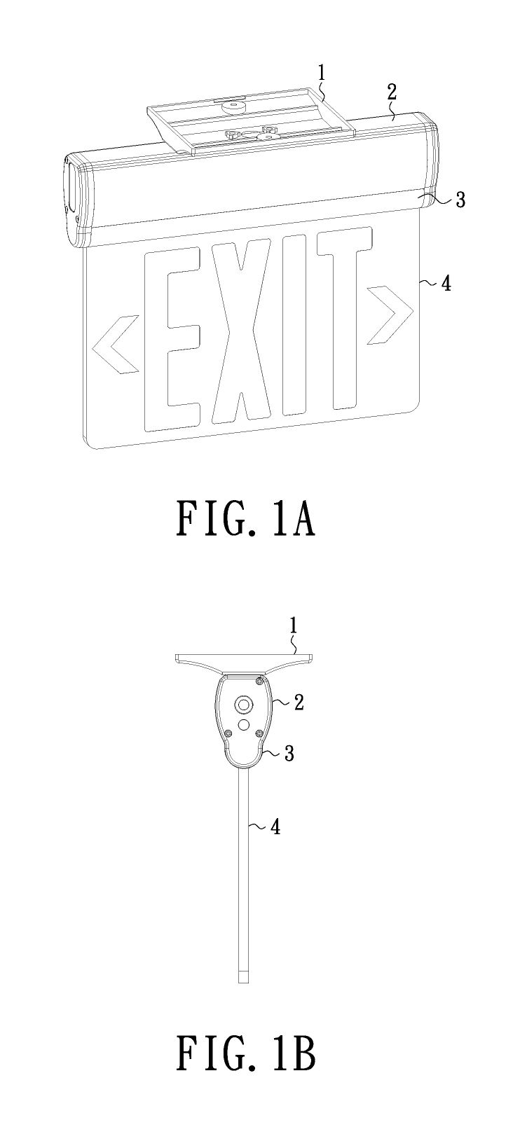

FIG. 1A is a schematic diagram of an overall structure of an emergency-light indicator in accordance with an embodiment of the present invention. As depicted in FIG. 1A, the emergency-light indicator, from top to down, comprises a top plate 1, a body 2, a rotating body 3 and an indication board module 4. FIGS. 1B and 1C are schematic side and front diagrams of the emergency-light indicator in accordance with an embodiment of the present invention, respectively.

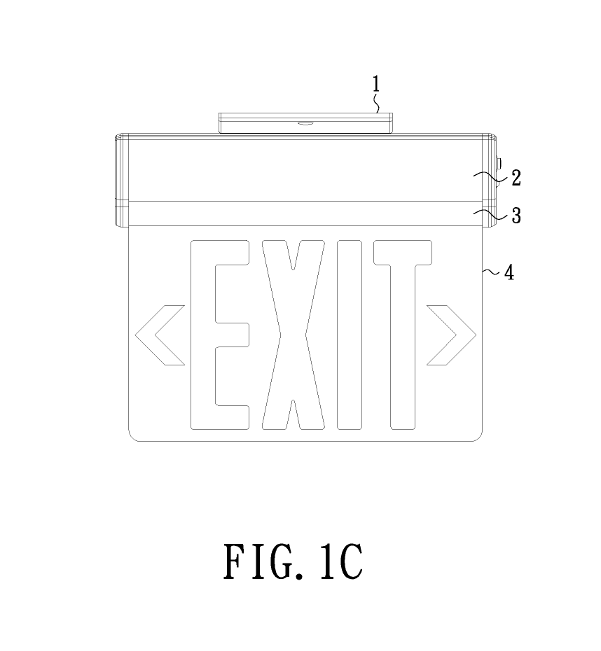

FIG. 2 is a schematic exploded diagram of the emergency-light indicator as depicted in FIG. 1. As depicted in FIG. 2, the body 2 is comprised of a chassis 21 and a front cover 22; herein the chassis 21 and the front cover 22 can be latched to each other. An isolation box 24 is configured (i.e., structured and arranged) inside the body 2. A transformer 25, a chargeable nickel-cadmium cell 26 and a PCB (Printed Circuit Board) module (e.g., control circuit board) 27 are configured in the isolation box 24. Herein, the integration of the isolation box 24, the transformer 25, the chargeable nickel-cadmium cell 26 and the PCB module 27 is referred to a driving power module which is configured to continually supply driving power to the emergency-light indicator.

The rotating body 3 has a round and tubular shape. Inside the rotating body 3, a latching slot (not shown) is longitudinal structured on the top thereof. An LED (Light Emitting Diode) PCB 31 is configured in the latching slot, and multiple LEDs 311, for providing the emergency light, are evenly configured on the LED PCB 31. A rotating side cover 32 is configured at each end of the rotating body 3 and a spring strip 33 is fixedly installed to each of the rotating side covers 32. A mounting slot, for installing the indication board module 4, is longitudinal structured on the bottom of the rotating body 3.

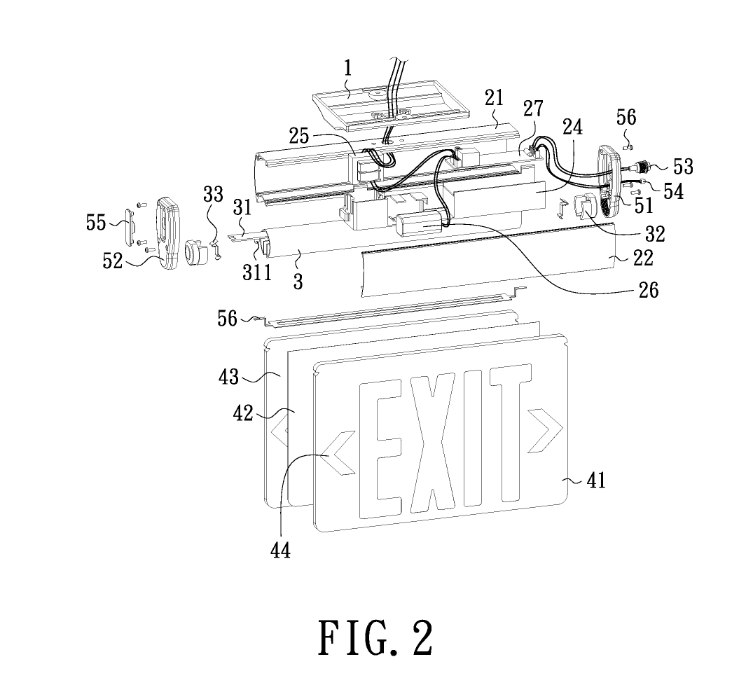

The indication board module 4 is structured by a first acrylic board 41, an aluminum reflector board 42 and a second acrylic board 43; herein the aluminum reflector board 42 is configured between the first acrylic board 41 and the second acrylic board 43. A plurality of stickers 44, for showing the indication direction or indication information, are configured on the two acrylic boards 41. A groove 45 is structured at each left and right side of the indication board module 4, and the positions of the two grooves 45 are corresponding to the positions of the two spring strips 33. The two spring strips 33 can be latched to or unlatched from the two grooves 45, thereby the indication board module 4 can be latched to or unlatched from the rotating body 3. FIG. 3 is a schematic diagram illustrating the indication board module 4 can be installed to or uninstalled from the rotating body 3 through the two spring strips 33 and the corresponding two grooves 45. As depicted in FIG. 3, the indication board module 4 can be installed to the rotating body 3 through latching the two spring strips 33 to the corresponding two grooves 45; and based on the same manner, the indication board module 4 can uninstalled to the rotating body 3 through unlatching the two spring strips 33 to the corresponding two grooves 45.

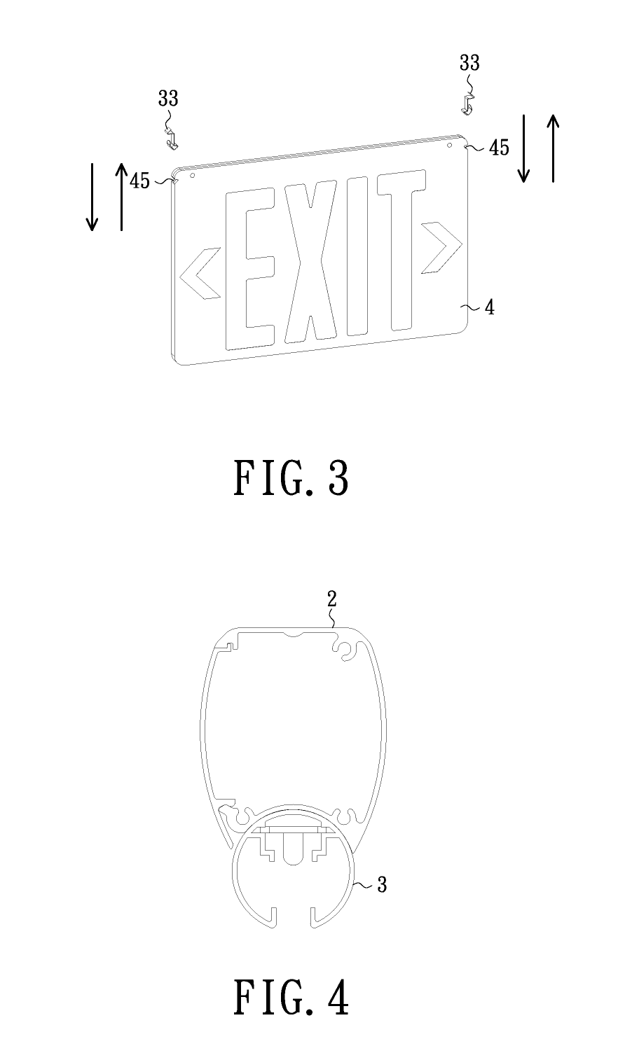

Please referring back to FIG. 2, a contacting surface, of the body 2 and corresponding to the rotating body 3, has an inner-arc structure. The body 2 and the rotating body 3 can be installed together through a right side cover 51 and a left side cover 52; specifically, a plurality of screws 56 are used for installing the right side cover 51 and the left side cover 52 to the chassis 21. Because the two rotating side covers 32 are capable of correspondingly rotating inside the right side cover 51 and the left side cover 52 and a friction is resulted on the inner-arc structure between the body 2 and the rotating body 3, accordingly corresponding to the body 2 the rotating body 3 can rotate to a specific angle. It is noticed that along with the rotating body 3, corresponding to the body 2 the indication board module 4 can also rotate to a specific angle. FIG. 4 is a schematic side cross section diagram of the body 2 and the rotating body 3. As depicted in FIG. 4, corresponding to the body 2 the rotating body 3 can rotate to a specific angle.

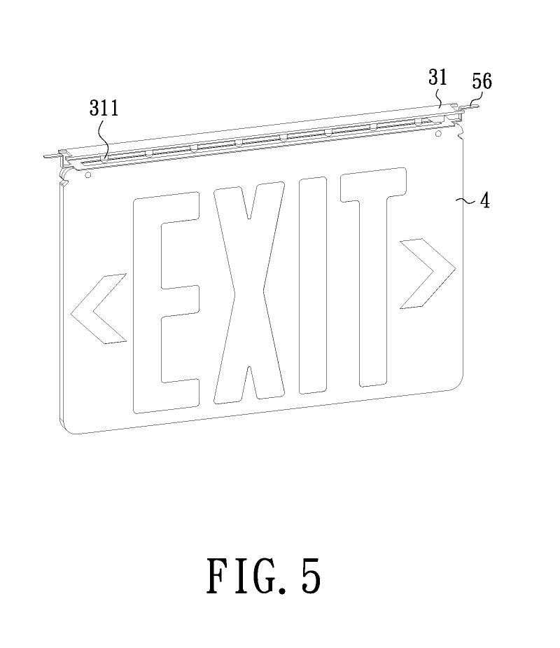

Please referring back to FIG. 2, a light-blocking board 56 with a crack structure is configured between the LED PCB 31 and the indication board module 4. FIG. 5 is a schematic diagram illustrating the function of the light-blocking board 34 used on the indication board module 4. As depicted in FIG. 5, while the light-blocking board 56 is pushed forwardly, the light from the multiple LEDs 311 and emitted to the back of the indication board module 4 (or, the second acrylic board 43) is blocked by the light-blocking board 34, thereby through the crack structure of the light-blocking board 56 only the front of the indication board module 4 (or, the first acrylic board 41) is lighted. Or, while the light-blocking board 56 is pushed backwardly, the light from the multiple LEDs 311 and emitted to the front of the indication board module 4 (or, the first acrylic board 41) is blocked by the light-blocking board 34, thereby through the crack structure of the light-blocking board 56 only the back of the indication board module 4 (or, the second acrylic board 43) is lighted. Or, while the light-blocking board 56 is moved at a middle position, through the crack structure of the light-blocking board 56 both the front and back of the indication board module 4 (or, the first and second acrylic boards 41 and 43) are lighted.

Please refer back to FIG. 2. Through a hole of the right side cover 51, a testing switch 53 and an LED indication light 54 are electrically coupled to the PCB module 27. A hole cover 55 is configured on the left side cover 52.

To sum up, because the indication board module is detachable to the emergency-light indicator in the present invention, the indication board module can be packaged independently in the manufacturing process; thereby a reduction of the packaging consumables and transportation cost is achieved. Moreover, it is much convenient for a user to replace or clean the indication board module without detaching the whole emergency-light indicator from a wall. In addition, because along with the rotating body the indication board module is capable of rotating to the body, the emergency-light indicator can be installed on a wall or a ceiling based on an actual situation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An emergency-light indicator, comprising:
a body, comprising a driving power module inside;
a rotating body, configured on a bottom of the body and comprising an LED board inside, wherein the rotating body is installed to the body through two side covers which are respectively configured at two ends of the body and the rotating body;
an indication board module; and
a top plate, configured on a top of the body;
wherein a mounting slot is structured on a bottom of the rotating body, a rotating side cover is configured at each end of the rotating body, a spring strip is fixedly installed to each of the rotating side covers, a groove is structured at each right and left side of the indication board module and the grooves are corresponding to the spring strips, thereby the indication board module can be installed to the mounting slot through a latch of the spring trips and the corresponding grooves.

2. The emergency-light indicator according to claim 1, wherein the driving power module comprises an isolation box with a transformer, a chargeable nickel-cadmium cell and a control circuit board inside, and a testing switch and an LED indication light are electrically coupled to the control circuit board.

3. The emergency-light indicator according to claim 2, wherein the rotating body has a round and tubular shape, a contacting surface, of the body and corresponding to the rotating body, has an inner-arc structure, each of the rotating side covers is capable of rotating inside its corresponding side cover and a friction is resulted on the contacting surface, thereby corresponding to the body the rotating body can rotate to a specific angle.

4. The emergency-light indicator according to claim 1, wherein the rotating body has a round and tubular shape, a contacting surface, of the body and corresponding to the rotating body, has an inner-arc structure, each of the rotating side covers is capable of rotating inside its corresponding side cover and a friction is resulted on the contacting surface, thereby corresponding to the body the rotating body can rotate to a specific angle.

5. The emergency-light indicator according to claim 1, wherein the indication board module comprises:
a first acrylic board;
a second acrylic board; and
a light reflecting board, configured between the first and the second acrylic boards;
wherein a light-block board with a crack structure is configured between the indication board module and the LED board, light from the LED board is emitted to the first acrylic board through the crack structure of the light-block board while the light-block board is moved to a first position, light from the LED board is emitted to the second acrylic board through the crack structure of the light-block board while the light-block board is moved to a second position, light from the LED board is emitted to both the first and second acrylic boards through the crack structure of the light-block board while the light-block board is moved to a third position.
